(19) United States
(12) Patent Application Publication
(10) Pub. No.: US 2022/0058921 A1
(43) Pub. Date: Feb. 24, 2022

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventor: Keiji HASEGAWA, Tokyo (JP)

(73) Assignee: NEC Corporation, Minato-ku, Tokyo (JP)

(21) Appl. No.: 17/416,594

(22) PCT Filed: Oct. 30, 2019
(86) PCT No.: PCT/JP2019/042564

§ 371 Date: Jun. 21, 2021

(30) Foreign Application Priority Data
Dec. 28, 2018 (JP) 2018-247637

(51) Int. Cl. G07G 1/00; G06Q 20/20; G07G 1/06

(52) U.S. Cl. CPC G07G 1/0009; G07G 1/06; G06Q 20/209

(57) ABSTRACT

The present invention provides a processing apparatus (10) including a customer identification information acquisition unit (11) that acquires customer identification information, a request information acquisition unit (12) that acquires, from a server that stores customer registration information in which request information indicating whether issue of an electronic receipt is requested is registered in association with the customer identification information, the request information stored in association with the customer identification information acquired by the customer identification information acquisition unit (11), and a display control unit (13) that displays, on a display, at least either one of an inquiry screen that inquires about whether to issue a paper receipt and a checkout details screen indicating at least a part of information included in an electronic receipt, when a content of the acquired request information requests issue of the electronic receipt.

### TECHNICAL FIELD

The present invention relates to a processing apparatus, a processing method, and a program.

### BACKGROUND ART

PTL 1 discloses a checkout apparatus that displays, on a display, a screen including an image of a receipt and a button that specifies whether to issue the receipt, and issues a paper receipt when issue of the receipt is specified.

PTL 2 discloses a checkout apparatus that displays, on a display, a screen including a button associated with each of “no need to print paper receipt”, “request issue of electronic receipt”, and “request both paper receipt and electronic receipt”, and performs receipt issuing processing with a content specified by a customer.

### RELATED DOCUMENT

### Patent Document

[Patent Document 1] Japanese Patent Application Publication No. 2013-54632

[Patent Document 2] Japanese Patent Application Publication No. 2004-151838

### DISCLOSURE OF THE INVENTION

### Technical Problem

Economy in a paper resource is achieved by not issuing a paper receipt for a customer who requests issue of an electronic receipt. However, there is a problem that it is difficult for a customer who does not receive a paper receipt to confirm a checkout content immediately after checkout processing. For example, a customer who purchases a discount product, a customer who purchases a high-priced product, and the like may request confirmation of whether checkout processing is properly performed without a registration mistake and the like.

According to the techniques described in PTLs 1 and 2, a customer can select whether to issue a paper receipt at a time of checkout processing. However, in a case of the techniques described in PTLs 1 and 2, a screen for inquiring whether to issue a paper receipt is displayed for all customers who perform checkout processing, and an input for specifying whether to issue a receipt is received. In this case, efficiency of the checkout processing is reduced, and inconvenience that waiting time for a checkout increases and the like may occur.

The present invention has a challenge that a customer who requests issue of an electronic receipt is able to confirm a checkout content during checkout processing and immediately after the checkout processing while a reduction in efficiency of the checkout processing is suppressed.

### Solution to Problem

The present invention provides a processing apparatus including, a customer identification information acquisition unit that acquires customer identification information,

a request information acquisition unit that acquires, from a server that stores customer registration information in which request information indicating whether issue of an electronic receipt is requested is registered in association with the customer identification information, the request information stored in association with the customer identification information acquired by the customer identification information acquisition unit, and

a display control unit that displays, on a display, at least either one of an inquiry screen that inquires about whether to issue a paper receipt and a checkout details screen indicating at least a part of information included in an electronic receipt, when a content of the acquired request information requests issue of the electronic receipt.

Further, the present invention provides a processing method executed by a computer, including,

a customer identification information acquisition step of acquiring customer identification information,

a request information acquisition step of acquiring, from a server that stores customer registration information in which request information indicating whether issue of an electronic receipt is requested is registered in association with the customer identification information, the request information stored in association with the customer identification information acquired in the customer identification information acquisition step, and

a display control step of displaying, on a display, at least either one of an inquiry screen that inquires about whether to issue a paper receipt and a checkout details screen indicating at least a part of information included in an electronic receipt, when a content of the acquired request information requests issue of the electronic receipt.

Further, the present invention provides a program for causing a computer to function as

a customer identification information acquisition unit that acquires customer identification information,

a request information acquisition unit that acquires, from a server that stores customer registration information in which request information indicating whether issue of an electronic receipt is requested is registered in association with the customer identification information, the request information stored in association with the customer identification information acquired by the customer identification information acquisition unit, and

a display control unit that displays, on a display, at least either one of an inquiry screen that inquires about whether to issue a paper receipt and a checkout details screen indicating at least a part of information included in an electronic receipt, when a content of the acquired request information requests issue of the electronic receipt.

### Advantageous Effects of Invention

The present invention enables a customer who requests issue of an electronic receipt to confirm a checkout content during checkout processing and immediately after the checkout processing while a reduction in efficiency of the checkout processing is suppressed.

### BRIEF DESCRIPTION OF THE DRAWINGS

The above-described object, the other objects, features, and advantages will become more apparent from suitable example embodiments described below and the following accompanying drawings.

FIG. 1 is a diagram illustrating one example of a hardware configuration of a processing apparatus according to a present example embodiment.

FIG. 2 is one example of a functional block diagram of the processing apparatus according to the present example embodiment.

FIG. 3 is one example of a functional block diagram of the processing apparatus according to the present example embodiment.

FIG. 4 is a flowchart illustrating one example of a flow of processing of the processing apparatus according to the present example embodiment.

FIG. 5 is a flowchart illustrating one example of a flow of processing of the processing apparatus according to the present example embodiment.

FIG. 6 is a diagram schematically illustrating one example of a screen displayed on a customer-specific display by the processing apparatus according to the present example embodiment.

FIG. 7 is a flowchart illustrating one example of a flow of processing of the processing apparatus according to the present example embodiment.

FIG. 8 is a sequence diagram illustrating one example of a flow of processing of the processing apparatus according to the present example embodiment.

FIG. 9 is a sequence diagram illustrating one example of a flow of processing of the processing apparatus according to the present example embodiment.

FIG. 10 is a flowchart illustrating one example of a flow of processing of the processing apparatus according to the present example embodiment.

FIG. 11 is a diagram schematically illustrating one example of a screen displayed on the customer-specific display by the processing apparatus according to the present example embodiment.

FIG. 12 is a flowchart illustrating one example of a flow of processing of the processing apparatus according to the present example embodiment.

FIG. 13 is a flowchart illustrating one example of a flow of processing of the processing apparatus according to the present example embodiment.

FIG. 14 is a sequence diagram illustrating one example of a flow of processing of the processing apparatus according to the present example embodiment.

FIG. 15 is a sequence diagram illustrating one example of a flow of processing of the processing apparatus according to the present example embodiment.

FIG. 16 is a diagram schematically illustrating one example of information processed by the processing apparatus according to the present example embodiment.

FIG. 17 is a diagram schematically illustrating one example of a screen displayed on the customer-specific display by the processing apparatus according to the present example embodiment.

### DESCRIPTION OF EMBODIMENTS

### First Example Embodiment

First, an outline of a processing apparatus according to a present example embodiment will be described. The processing apparatus is an apparatus used in checkout processing at a store, and is specifically a checkout apparatus (for example: a point of sales (POS) register) that performs registration processing and payment processing.

The registration processing is processing of registering information that identifies a product and a service to be checked out being input via an input apparatus such as a code reader, a touch panel display, a microphone, a camera, and a physical button. The payment processing is processing of receiving a payment of a checkout amount being fixed in the registration processing, and is processing of, for example, receiving insertion of cash, receiving an input of credit card information, performing settlement processing by communicating with a server of a credit card company, receiving an input of a tendered amount, computing a change, and discharging a computed change. Note that, the example herein is one example, which is not limited thereto.

The checkout apparatus may be physically and logically configured with one apparatus. Such a checkout apparatus may be an apparatus assumed to be operated by a salesclerk, and may be an apparatus assumed to be operated by a customer. In addition, the checkout apparatus may be formed of two apparatuses being separated physically and logically. For example, the checkout apparatus may be configured with a registration apparatus that performs the registration processing and a payment apparatus that performs the payment processing. The registration apparatus may be an apparatus assumed to be operated by a salesclerk, and the payment apparatus may be an apparatus assumed to be operated by a customer.

In the present example embodiment, request information indicating whether issue of an electronic receipt is requested is previously registered, in a server, in association with customer identification information.

The processing apparatus receives an input of customer identification information at any timing during checkout processing. Then, the processing apparatus requests, from the server, request information associated with the customer identification information, and acquires the request information.

When a content of the acquired request information requests issue of an electronic receipt, the processing apparatus displays, on a customer-specific display, at least either one of an “inquiry screen that inquires about whether to issue a paper receipt” and a “checkout details screen indicating at least a part of information included in an electronic receipt” at any timing.

When the processing apparatus displays the inquiry screen, the processing apparatus receives an instruction input indicating whether to issue a paper receipt. Then, when the processing apparatus receives an instruction input for issuing a paper receipt, the processing apparatus issues the paper receipt after the end of the payment processing. On the other hand, when the processing apparatus receives an instruction input for not issuing a paper receipt, the processing apparatus does not issue the paper receipt.

When a content of the acquired request information does not request issue of an electronic receipt, the processing apparatus does not display, on the customer-specific display, the inquiry screen or the checkout details screen described above. In this case, the processing apparatus issues a paper receipt after the end of the payment processing.

In this way, the processing apparatus according to the present example embodiment switches a processing content to be performed, depending on whether a customer requests issue of an electronic receipt.

Next, a configuration of the processing apparatus will be described in detail. First, one example of a hardware configuration of the processing apparatus will be described. Each functional unit included in the processing apparatus according to the present example embodiment is achieved by any combination of hardware and software concentrating on a central processing unit (CPU) of any computer, a memory, a program loaded into the memory, a storage unit (that can also store a program downloaded from a storage medium such as a compact disc (CD), a server on the Internet, and the like in addition to a program previously stored at a stage of shipping of an apparatus) such as a hard disk that stores the program, and a network connection interface. Then, various modification examples of an achievement method and an apparatus thereof are understood by a person skilled in the art.

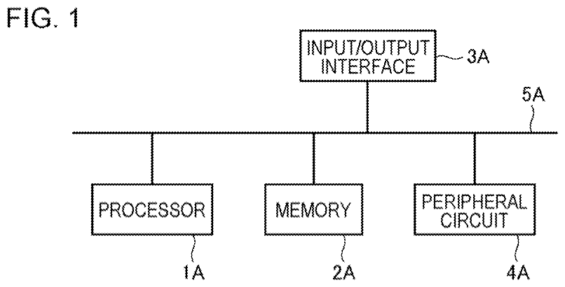

FIG. 1 is a block diagram illustrating a hardware configuration of the processing apparatus according to the present example embodiment. As illustrated in FIG. 1, the processing apparatus includes a processor 1A, a memory 2A, an input/output interface 3A, a peripheral circuit 4A, and a bus 5A. Various modules are included in the peripheral circuit 4A. The processing apparatus may not include the peripheral circuit 4A. Note that, the processing apparatus may be formed of a plurality of apparatuses being separated physically and/or logically. In this case, each of the plurality of apparatuses can include the hardware configuration described above.

The bus 5A is a data transmission path for the processor 1A, the memory 2A, the peripheral circuit 4A, and the input/output interface 3A to transmit and receive data to and from each other. The processor 1A is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can output an instruction to each of modules, and perform an arithmetic operation, based on an arithmetic result of the modules.

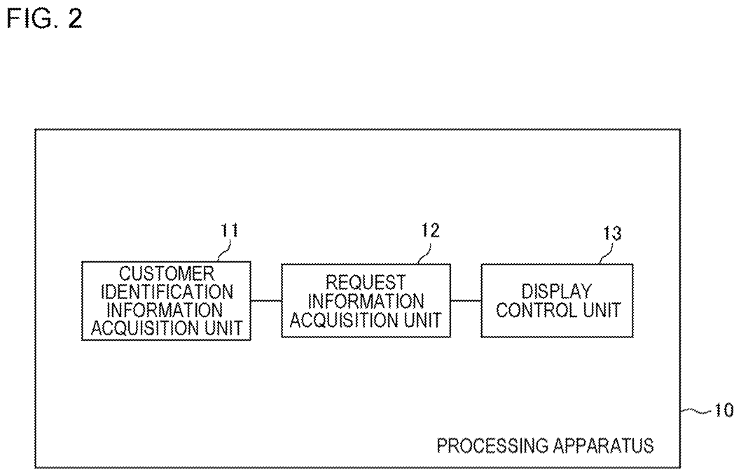

Next, one example of a functional configuration of the processing apparatus will be described. As illustrated in a functional block diagram in FIG. 2, a processing apparatus 10 includes a customer identification information acquisition unit 11, a request information acquisition unit 12, and a display control unit 13.

The customer identification information acquisition unit 11 acquires customer identification information input to the processing apparatus 10. The customer identification information is input to the processing apparatus 10 via an input apparatus such as a reader/writer including a near field communication function, a card reader, a physical button, a touch panel, a microphone, and a camera, for example. Note that, the input apparatus exemplified herein is one example, which is not limited thereto. One example of timing at which an input of customer identification information is received will be described in the following example embodiment.

The request information acquisition unit 12 requests, from a server, request information stored in association with the customer identification information acquired by the customer identification information acquisition unit 11, and acquires the request information. The request information is information indicating whether issue of an electronic receipt is requested. The server stores customer registration information in which request information is registered in association with customer identification information. One example of timing at which request information is requested from the server and acquired will be described in the following example embodiment.

When a content of the request information acquired by the request information acquisition unit 12 requests issue of an electronic receipt, the display control unit 13 displays, on a customer-specific display, at least either one of an inquiry screen and a checkout details screen. The customer-specific display is a display installed in a position and an orientation that can be viewed by a customer. One example of timing at which at least either one of the inquiry screen and the checkout details screen is displayed on the customer-specific display will be described in the following example embodiment.

The checkout details screen is a screen indicating at least a part of information included in an electronic receipt. For example, information that identifies a product and a service registered as a checkout target, the number of registered items, a price, presence or absence of a discount, and the like may be displayed on the checkout details screen. In addition, a subtotal, a consumption tax, a tendered amount, a change, a payment method, and the like may be displayed on the checkout details screen.

The inquiry screen is a screen that inquires about whether to issue a paper receipt, and receives an instruction input indicating whether to issue the paper receipt. For example, the inquiry screen may include a sentence such as “Issue paper receipt?” and a user interface (UI) button associated with each of “Yes” and “No”.

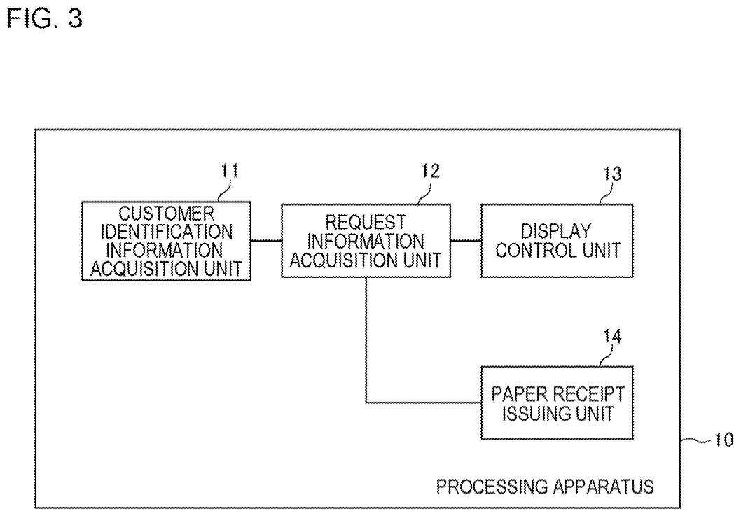

Note that, when the display control unit 13 is configured to display the inquiry screen on the customer-specific display, the processing apparatus 10 further includes a paper receipt issuing unit 14 as illustrated in a functional block diagram in FIG. 3. When the paper receipt issuing unit 14 receives an instruction input for issuing a paper receipt on the inquiry screen, the paper receipt issuing unit 14 issues the paper receipt after the end of payment processing. On the other hand, when the paper receipt issuing unit 14 receives an instruction input for not issuing a paper receipt, the paper receipt issuing unit 14 does not issue the paper receipt.

The processing apparatus 10 described above does not basically issue a paper receipt for a customer who requests issue of an electronic receipt. Thus, economy in a paper resource is achieved.

Further, when a customer requests issue of an electronic receipt, the processing apparatus 10 can, for example, display, on a customer-specific display, an inquiry screen that inquires about whether to issue a paper receipt, and issue the paper receipt in response to an instruction input from a user. Thus, a customer who requests issue of the electronic receipt can acquire a paper receipt by performing an instruction input for issue of the paper receipt from the inquiry screen. Then, the customer can confirm a checkout content immediately after checkout processing by confirming the paper receipt.

Further, when a customer requests issue of an electronic receipt, the processing apparatus 10 can, for example, display, on a customer-specific display, a checkout details screen indicating at least a part of information included in the electronic receipt. Thus, a customer who requests issue of the electronic receipt can confirm a checkout content during checkout processing and immediately after the checkout processing by viewing the checkout details screen.

Further, the processing apparatus 10 can provide the inquiry screen and the checkout details screen to only a customer who requests issue of an electronic receipt instead of providing the screens to all customers. Thus, a reduction in efficiency of checkout processing can be suppressed as compared to a case where the inquiry screen and the checkout details screen are provided to all customers. Note that, since a paper receipt is issued for a customer who does not request issue of an electronic receipt, inconvenience that the customer cannot confirm a checkout content immediately after checkout processing does not occur.

### Second Example Embodiment

In a present example embodiment, a configuration of a processing apparatus 10 is defined as follows, and then a specific example of a flow of processing will be described.
The processing apparatus 10 is a checkout apparatus being physically and logically configured with one apparatus.
The processing apparatus 10 is an apparatus assumed to be operated by a salesclerk or a customer.
The processing apparatus 10 displays a checkout details screen for a customer who requests issue of an electronic receipt.

A hardware configuration of the processing apparatus 10 is similar to that in the first example embodiment. One example of a functional block diagram of the processing apparatus 10 is illustrated in FIG. 2. A configuration of a customer identification information acquisition unit 11, a request information acquisition unit 12, and a display control unit 13 is similar to that in the first example embodiment.

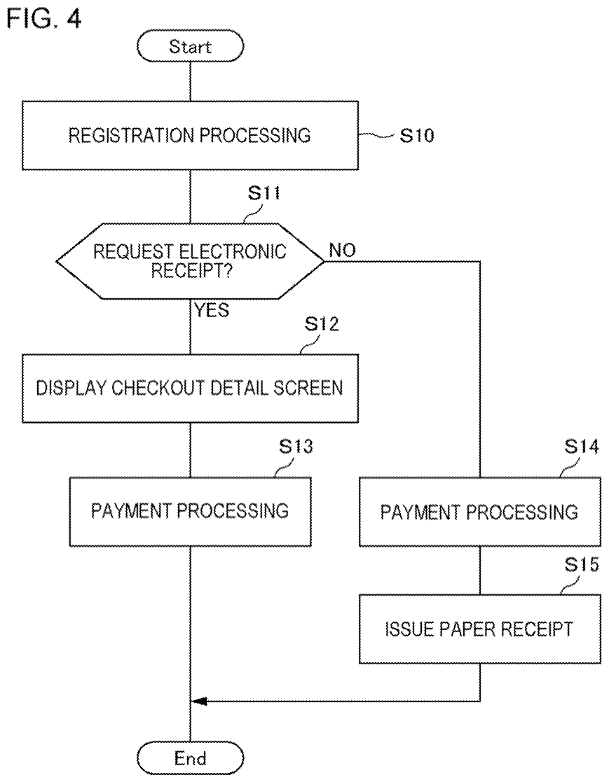

Herein, one example of a flow of processing of the processing apparatus 10 will be described by using a flowchart in FIG. 4.

First, the processing apparatus 10 performs registration processing (S10). Specifically, the processing apparatus 10 receives an input of information that identifies a product and a service to be checked out. A salesclerk or a customer inputs information that identifies a product and a service to be checked out via an input apparatus included in the processing apparatus 10 or an input apparatus connected to the processing apparatus 10. A code reader, a touch panel display, a microphone, a camera, a physical button, and the like are exemplified as the input apparatus, which is not limited thereto.

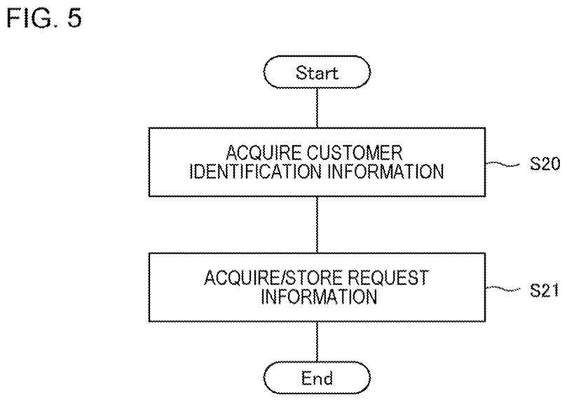

Further, the processing apparatus 10 can perform processing illustrated in a flowchart in FIG. 5 at any timing during the registration processing. First, the processing apparatus 10 receives an input of customer identification information, and acquires the customer identification information (S20). A salesclerk or a customer inputs the customer identification information via an input apparatus included in the processing apparatus 10 or an input apparatus connected to the processing apparatus 10. A reader/writer, a card reader, a physical button, a microphone, a camera, and the like are exemplified as the input apparatus, which is not limited thereto.

Then, the processing apparatus 10 acquires, from a server, request information stored in association with the acquired customer identification information, and stores the request information (S21). The request information is information indicating whether issue of an electronic receipt is requested.

Referring back to the flowchart in FIG. 4, when the processing apparatus 10 receives a user input for starting payment processing, the processing apparatus 10 ends the registration processing in S10. Next, the processing apparatus 10 determines whether the customer requests issue of an electronic receipt (S11). Specifically, the processing apparatus 10 reads the request information acquired from the server by performing the processing in FIG. 5 during S10, and confirms a content of the request information.

When the content of the request information requests issue of the electronic receipt (Yes in S11), the processing apparatus 10 displays a checkout details screen on a customer-specific display (S12).

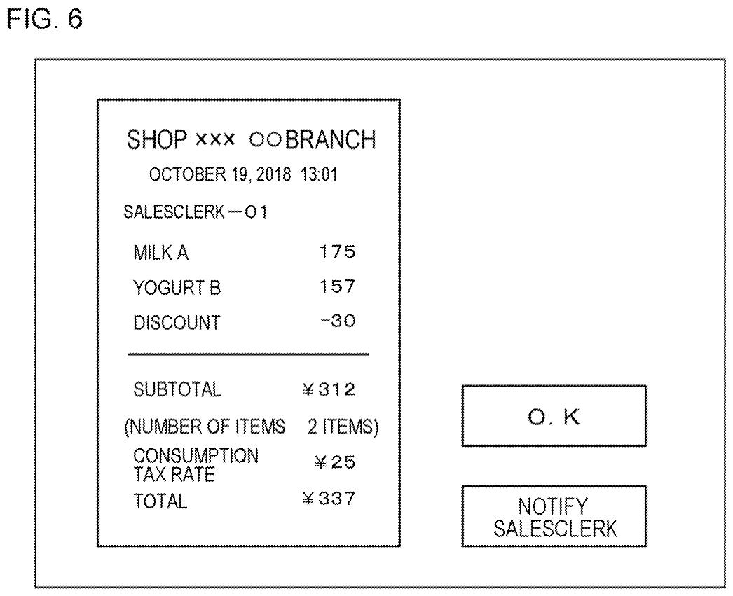

The processing apparatus 10 displays the checkout details screen as illustrated in FIG. 6, for example, on the customer-specific display. On the illustrated checkout details screen, an electronic receipt including information that identifies a product and a service registered as a checkout target, the number of registered items, a price, presence or absence of a discount, a subtotal, a consumption tax, a checkout amount, and the like is displayed. Furthermore, on the illustrated checkout details screen, a UI button associated with each of “O.K.” and “notify salesclerk” is displayed.

When an input for specifying the “O.K.”, illustrated, is received, the processing apparatus 10 proceeds to S13, and performs payment processing. In the payment processing, for example, the processing apparatus 10 receives insertion of cash, receives an input of credit card information, performs settlement processing by communicating with a server of a credit card company, receives an input of a tendered amount, computes a change, and discharges a computed change.

On the other hand, when an input for specifying the “notify salesclerk”, illustrated, is received, the processing apparatus 10 performs processing (warning processing) of notifying a salesclerk. In the processing of notifying a salesclerk, for example, the processing apparatus 10 may display a sentence such as “customer wants to confirm registration content” on a salesclerk-specific display. In addition, the processing apparatus 10 may light a warning lamp and make a warning sound. The processing apparatus 10 can include a warning means for performing such warning processing. Processing after the warning processing can be designed in various ways, but, for example, the processing apparatus 10 may receive an input for changing a content registered in the registration processing, and return to S12 after completion of the change. In this case, in S12, a checkout details screen based on a registration content after the change is displayed on the customer-specific display.

On the other hand, when the content of the request information does not request issue of the electronic receipt (No in S11), the processing apparatus 10 performs the payment processing (S14), then issues a paper receipt (S15), and ends the processing.

Note that, an electronic receipt displayed on the checkout details screen may be generated by the processing apparatus 10, and may be generated by an external apparatus (for example: a store server) configured to be communicable to the processing apparatus 10.

Further, in the example described above, the processing apparatus 10 performs the processing in FIG. 5 during the registration processing, but the processing apparatus 10 may perform the processing in FIG. 5 after the registration processing ends.

The processing apparatus 10 according to the present example embodiment described above can achieve an advantageous effect similar to that in the first example embodiment.

Further, the processing apparatus 10 according to the present example embodiment can receive an input of customer identification information during registration processing, and acquire request information. The processing for acquiring the request information can be performed simultaneously with the registration processing, and thus a reduction in efficiency of checkout processing can be suppressed.

Further, the processing apparatus 10 according to the present example embodiment displays a checkout details screen on a customer-specific display, confirms that there is no problem (receives an input for specifying the “O.K.” button in FIG. 6), and then performs payment processing. Thus, inconvenience that the payment processing is performed in presence of an error in a registration content can be suppressed.

### Third Example Embodiment

In a present example embodiment, a configuration of a processing apparatus 10 is defined as follows, and then a specific example of a flow of processing will be described. Note that, the following conditions of the processing apparatus 10 are similar to those in the second example embodiment.
The processing apparatus 10 is a checkout apparatus being physically and logically configured with one apparatus.
The processing apparatus 10 is an apparatus assumed to be operated by a salesclerk or a customer.
The processing apparatus 10 displays a checkout details screen for a customer who requests issue of an electronic receipt.

A hardware configuration of the processing apparatus 10 is similar to that in the first and second example embodiments. One example of a functional block diagram of the processing apparatus 10 is illustrated in FIG. 2. A configuration of a customer identification information acquisition unit 11, a request information acquisition unit 12, and a display control unit 13 is similar to that in the first and second example embodiments.

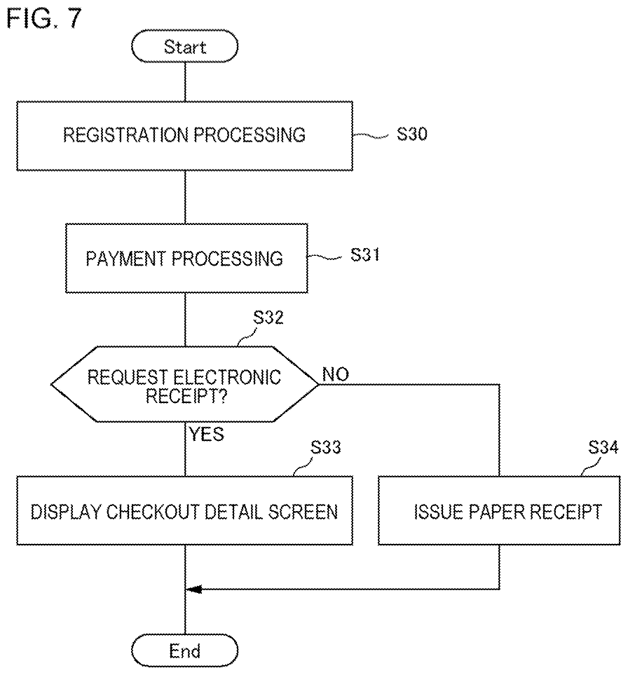

Herein, one example of a flow of processing of the processing apparatus 10 will be described by using a flowchart in FIG. 7.

First, the processing apparatus 10 performs registration processing (S30). A content of the processing in S30 is similar to the processing content in S10 described in the second example embodiment. Further, the processing apparatus 10 can perform the processing in FIG. 5 during the registration processing in S30.

When the processing apparatus 10 receives a user input for starting payment processing, the processing apparatus 10 ends the registration processing in S30, and performs the payment processing (S31). In other words, for example, the processing apparatus 10 receives insertion of cash, receives an input of credit card information, performs settlement processing by communicating with a server of a credit card company, receives an input of a tendered amount, computes a change, and discharges a computed change.

After the payment processing ends, the processing apparatus 10 determines whether the customer requests issue of an electronic receipt (S32). Specifically, the processing apparatus 10 reads request information acquired from a server by performing the processing in FIG. 5 during S30, and confirms a content of the request information.

When the content of the request information requests issue of the electronic receipt (Yes in S32), the processing apparatus 10 displays a checkout details screen on a customer-specific display (S33). The processing apparatus 10 displays the checkout details screen as illustrated in FIG. 6, for example, on the customer-specific display.

When an input for specifying an “O.K.”, illustrated, is received, the processing apparatus 10 ends the processing.

On the other hand, when an input for specifying a “notify salesclerk”, illustrated, is received, the processing apparatus 10 performs processing (warning processing) of notifying a salesclerk, and ends the processing. In the processing of notifying a salesclerk, for example, the processing apparatus 10 may display a sentence such as “customer wants to confirm registration content” on a salesclerk-specific display. In addition, the processing apparatus 10 may light a warning lamp and make a warning sound. The processing apparatus 10 can include a warning means for performing such warning processing.

Note that, when the content of the request information does not request issue of the electronic receipt (No in S32), the processing apparatus 10 issues a paper receipt (S34), and ends the processing.

Note that, an electronic receipt displayed on the checkout details screen may be generated by the processing apparatus 10, and may be generated by an external apparatus (for example: a store server) configured to be communicable to the processing apparatus 10. Further, the processing apparatus 10 performs the processing in FIG. 5 during the registration processing, but the processing apparatus 10 may perform the processing in FIG. 5 after the registration processing ends.

The processing apparatus 10 according to the present example embodiment described above can achieve an advantageous effect similar to that in the first and second example embodiments.

Further, the processing apparatus 10 according to the present example embodiment performs processing of displaying a checkout details screen on a customer-specific display after payment processing instead of during registration processing and the payment processing, and confirming that there is no problem. The processing apparatus 10 according to the present example embodiment being configured in such a manner can also achieve an advantageous effect similar to that in the first and second example embodiments. As a result, a variety of design of the processing apparatus 10 is extended, which is preferable.

### Fourth Example Embodiment

In a present example embodiment, a configuration of a processing apparatus 10 is defined as follows, and then a specific example of a flow of processing will be described.
The processing apparatus 10 is a checkout apparatus configured with two apparatuses (a registration apparatus and a payment apparatus) being separated physically and logically.
The registration apparatus is an apparatus assumed to be operated by a salesclerk, and the payment apparatus is an apparatus assumed to be operated by a customer.
The processing apparatus 10 displays a checkout details screen for a customer who requests issue of an electronic receipt.

A hardware configuration of the processing apparatus 10 is similar to that in the first to third example embodiments. One example of a functional block diagram of the processing apparatus 10 is illustrated in FIG. 2. A configuration of a customer identification information acquisition unit 11, a request information acquisition unit 12, and a display control unit 13 is similar to that in the first to third example embodiments.

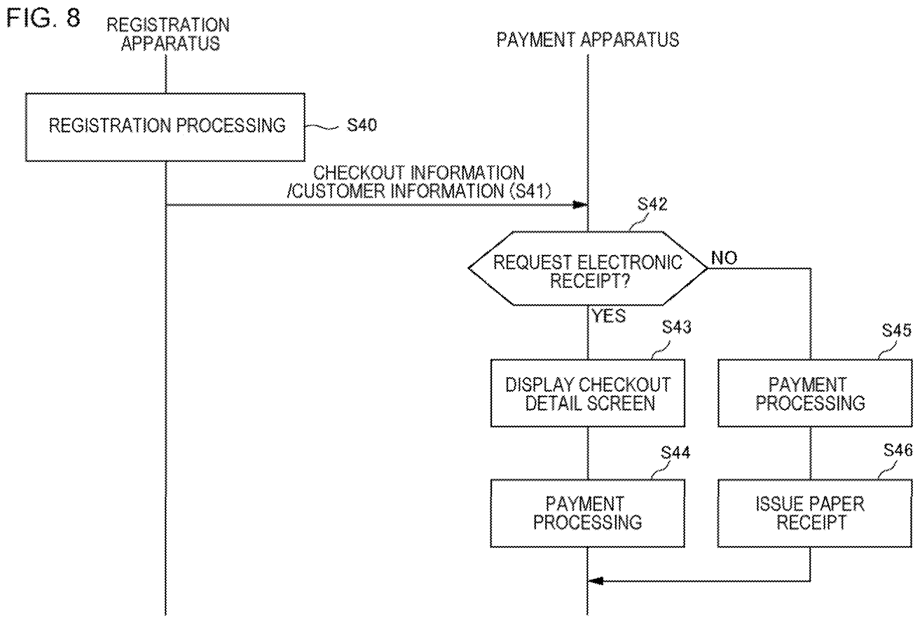

Herein, one example of a flow of processing of the processing apparatus 10 formed of the registration apparatus and the payment apparatus will be described by using a sequence diagram in FIG. 8.

First, the registration apparatus performs registration processing (S40). A content of the processing in S40 is similar to the processing content in S10 described in the second example embodiment. Further, the processing apparatus 10 can perform the processing in FIG. 5 during the registration processing in S40. When the registration apparatus receives a user input for ending the registration processing, the registration apparatus ends the registration processing in S40, and transmits checkout information and customer information to the payment apparatus (S41). The checkout information includes information that identifies a product and a service registered as a checkout target, the number of registered items, a price, presence or absence of a discount, a subtotal, a consumption tax, a checkout amount, and the like. The customer information is, for example, request information acquired by the processing apparatus 10 in the processing in FIG. 5.

The payment apparatus determines whether the customer requests issue of an electronic receipt, based on the request information acquired from the registration apparatus (S42).

When a content of the request information requests issue of the electronic receipt (Yes in S42), the payment apparatus displays a checkout details screen on a customer-specific display (S43). The payment apparatus displays the checkout details screen as illustrated in FIG. 6, for example, on the customer-specific display.

When an input for specifying an “O.K.”, illustrated, is received, the payment apparatus proceeds to S44, and performs payment processing, based on the checkout information received in S41. In the payment processing, for example, the payment apparatus receives insertion of cash, receives an input of credit card information, performs settlement processing by communicating with a server of a credit card company, receives an input of a tendered amount, computes a change, and discharges a computed change.

On the other hand, when an input for specifying a “notify salesclerk”, illustrated, is received, the payment apparatus performs processing (warning processing) of notifying a salesclerk. In the processing of notifying a salesclerk, for example, the payment apparatus may display a sentence such as “customer wants to confirm registration content” on a salesclerk-specific display. In addition, the payment apparatus may light a warning lamp and make a warning sound. The processing apparatus 10 can include a warning means for performing such warning processing. Processing after the warning processing can be designed in various ways, but, for example, the payment apparatus may receive an input for changing a content registered in the registration processing, and return to S43 after completion of the change. In this case, in S43, a checkout details screen based on a registration content after the change is displayed on the customer-specific display.

When the content of the request information does not request issue of the electronic receipt (No in S42), the payment apparatus performs the payment processing, based on the checkout information received in S41 (S45), then issues a paper receipt (S46), and ends the processing.

Note that, an electronic receipt displayed on the checkout details screen may be generated by the registration apparatus, may be generated by the payment apparatus, and may be generated by an external apparatus (for example: a store server) configured to be communicable to the registration apparatus and the payment apparatus.

Further, in the example described above, the registration apparatus performs the processing in FIG. 5 during the registration processing, but the registration apparatus may perform the processing in FIG. 5 after the registration processing ends. In addition, after the payment apparatus acquires checkout information from the registration apparatus, the payment apparatus may perform the processing in FIG. 5.

In addition, the registration apparatus may receive an input of customer identification information, but may not perform processing of acquiring request information from a server. In this case, the registration apparatus transmits, as customer information, the input customer identification information to the payment apparatus (S41). Then, the payment apparatus performs the processing in FIG. 5 by using the customer identification information acquired from the registration apparatus.

The processing apparatus 10 according to the present example embodiment described above can achieve an advantageous effect similar to that in the first to third example embodiments. In other words, the processing apparatus 10 according to the present example embodiment can achieve an advantageous effect similar to that in the first to third example embodiments even when the processing apparatus 10 is configured with two apparatuses (the registration apparatus and the payment apparatus) being separated physically and logically. As a result, a variety of design of the processing apparatus 10 is extended, which is preferable.

### Fifth Example Embodiment

In a present example embodiment, a configuration of a processing apparatus 10 is defined as follows, and then a specific example of a flow of processing will be described. Note that, the following conditions of the processing apparatus 10 are similar to those in the fourth example embodiment.
The processing apparatus 10 is a checkout apparatus configured with two apparatuses (a registration apparatus and a payment apparatus) being separated physically and logically.
The registration apparatus is an apparatus assumed to be operated by a salesclerk, and the payment apparatus is an apparatus assumed to be operated by a customer.
The processing apparatus 10 displays a checkout details screen for a customer who requests issue of an electronic receipt.

A hardware configuration of the processing apparatus 10 is similar to that in the first to fourth example embodiments. One example of a functional block diagram of the processing apparatus 10 is illustrated in FIG. 2. A configuration of a customer identification information acquisition unit 11, a request information acquisition unit 12, and a display control unit 13 is similar to that in the first to fourth example embodiments.

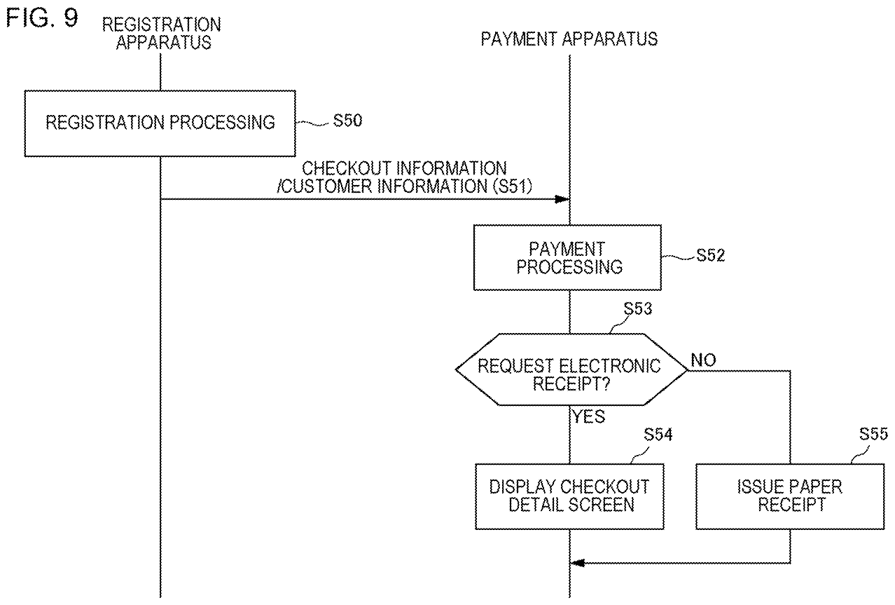

Herein, one example of a flow of processing of the processing apparatus 10 formed of the registration apparatus and the payment apparatus will be described by using a sequence diagram in FIG. 9.

First, the registration apparatus performs registration processing (S50). A content of the processing in S50 is similar to the processing content in S10 described in the second example embodiment. Further, the processing apparatus 10 can perform the processing in FIG. 5 during the registration processing in S50. When the registration apparatus receives a user input for ending the registration processing, the registration apparatus ends the registration processing in S50, and transmits checkout information and customer information to the payment apparatus (S51). The checkout information and the customer information are as described in the fourth example embodiment.

The payment apparatus performs payment processing, based on the checkout information received in S51 (S52). Next, the payment apparatus determines whether the customer requests issue of an electronic receipt, based on request information received in S51 (S53).

When a content of the request information requests issue of the electronic receipt (Yes in S53), the payment apparatus displays a checkout details screen on a customer-specific display (S54). The payment apparatus displays the checkout details screen as illustrated in FIG. 6, for example, on the customer-specific display.

When an input for specifying an “O.K.”, illustrated, is received, the payment apparatus ends the processing.

On the other hand, when an input for specifying a “notify salesclerk”, illustrated, is received, the payment apparatus performs processing (warning processing) of notifying a salesclerk, and ends the processing. In the processing of notifying a salesclerk, for example, the payment apparatus may display a sentence such as “customer wants to confirm registration content” on a salesclerk-specific display. In addition, the payment apparatus may light a warning lamp and make a warning sound. The processing apparatus 10 can include a warning means for performing such warning processing.

When the content of the request information does not request issue of the electronic receipt (No in S53), the payment apparatus issues a paper receipt (S55), and ends the processing.

Note that, an electronic receipt displayed on the checkout details screen may be generated by the registration apparatus, may be generated by the payment apparatus, and may be generated by an external apparatus (for example: a store server) configured to be communicable to the registration apparatus and the payment apparatus.

Further, in the example described above, the registration apparatus performs the processing in FIG. 5 during the registration processing, but the registration apparatus may perform the processing in FIG. 5 after the registration processing ends. In addition, after the payment apparatus acquires checkout information from the registration apparatus, the payment apparatus may perform the processing in FIG. 5.

In addition, the registration apparatus may receive an input of customer identification information, but may not perform processing of acquiring request information from a server. In this case, the registration apparatus transmits, as customer information, the input customer identification information to the payment apparatus (S51). Then, the payment apparatus performs the processing in FIG. 5 by using the customer identification information acquired from the registration apparatus.

The processing apparatus 10 according to the present example embodiment described above can achieve an advantageous effect similar to that in the first to fourth example embodiments. In other words, the processing apparatus 10 according to the present example embodiment can achieve an advantageous effect similar to that in the first to fourth example embodiments even when the processing apparatus 10 is configured with two apparatuses (the registration apparatus and the payment apparatus) being separated physically and logically. As a result, a variety of design of the processing apparatus 10 is extended, which is preferable.

### Sixth Example Embodiment

In a present example embodiment, a configuration of a processing apparatus 10 is defined as follows, and then a specific example of a flow of processing will be described.
The processing apparatus 10 is a checkout apparatus being physically and logically configured with one apparatus.
The processing apparatus 10 is an apparatus assumed to be operated by a salesclerk or a customer.
The processing apparatus 10 displays an inquiry screen for a customer who requests issue of an electronic receipt.

A hardware configuration of the processing apparatus 10 is similar to that in the first to fifth example embodiments. One example of a functional block diagram of the processing apparatus 10 is illustrated in FIG. 3. A configuration of a customer identification information acquisition unit 11, a request information acquisition unit 12, a display control unit 13, and a paper receipt issuing unit 14 is similar to that in the first to fifth example embodiments.

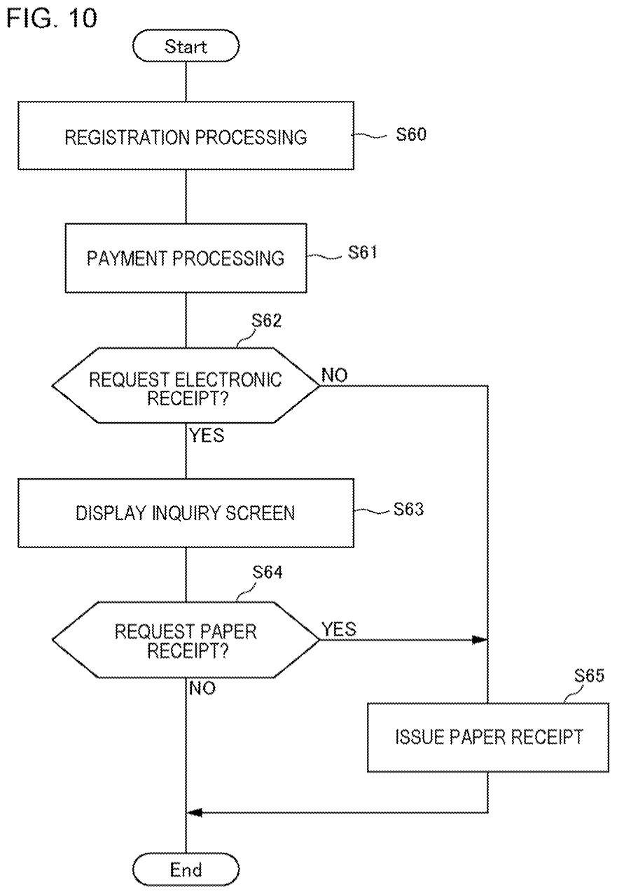

Herein, one example of a flow of processing of the processing apparatus 10 will be described by using a flowchart in FIG. 10.

First, the processing apparatus 10 performs registration processing (S60). A content of the processing in S60 is similar to the processing content in S10 described in the second example embodiment. Further, the processing apparatus 10 can perform the processing in FIG. 5 during the registration processing in S60.

Next, when the processing apparatus 10 receives a user input for starting payment processing, the processing apparatus 10 ends the registration processing in S60, and performs the payment processing (S61). Subsequently, the processing apparatus 10 determines whether the customer requests issue of an electronic receipt (S62). Specifically, the processing apparatus 10 reads request information acquired from a server by performing the processing in FIG. 5 during S60, and confirms a content of the request information.

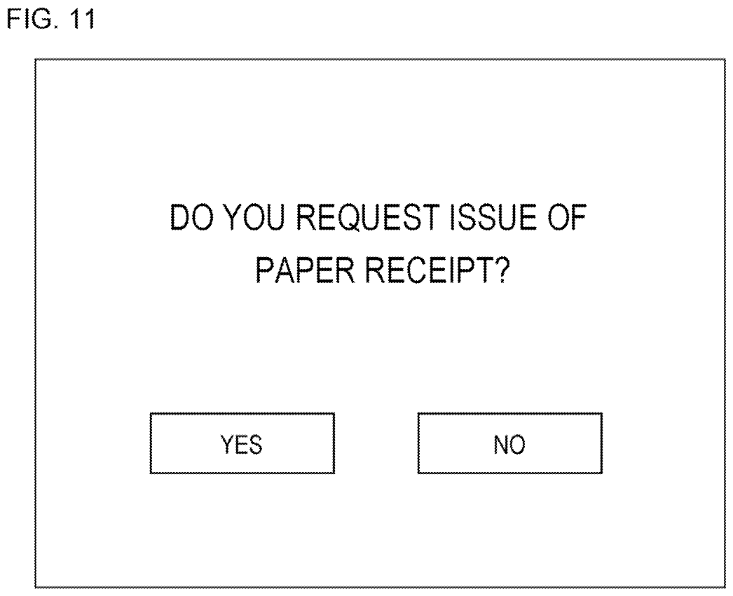

When the content of the request information requests issue of the electronic receipt (Yes in S62), the processing apparatus 10 displays an inquiry screen on a customer-specific display (S63). The inquiry screen is a screen that inquires about whether to issue a paper receipt, and receives an instruction input indicating whether to issue the paper receipt. For example, the processing apparatus 10 may display an inquiry screen as illustrated in FIG. 11 on the customer-specific display.

When an instruction input for issuing a paper receipt is received on the inquiry screen (Yes in S64), the processing apparatus 10 issues the paper receipt (S65), and ends the processing.

On the other hand, when the instruction input for issuing the paper receipt is not received on the inquiry screen (No in S64), the processing apparatus 10 ends the processing without issuing the paper receipt.

Further, when the content of the request information does not request issue of the electronic receipt (No in S62), the processing apparatus 10 issues the paper receipt (S65), and ends the processing.

Note that, in the example described above, the processing apparatus 10 performs the processing in FIG. 5 during the registration processing, but the processing apparatus 10 may perform the processing in FIG. 5 after the registration processing ends.

The processing apparatus 10 according to the present example embodiment described above can achieve an advantageous effect similar to that in the first to fifth example embodiments.

Further, in a case of the processing apparatus 10 according to the present example embodiment, a content displayed on the customer-specific display is “to inquire about whether to request issue of a paper receipt”, and thus an amount of information to be displayed can be reduced. Thus, time needed for a customer to confirm displayed information is reduced. As a result, inconvenience that efficiency of checkout processing is reduced due to the screen display and confirmation work by a customer can be suppressed.

### Seventh Example Embodiment

In a present example embodiment, a configuration of a processing apparatus 10 is defined as follows, and then a specific example of a flow of processing will be described. Note that, the following conditions of the processing apparatus 10 are similar to those in the sixth example embodiment.
The processing apparatus 10 is a checkout apparatus being physically and logically configured with one apparatus.
The processing apparatus 10 is an apparatus assumed to be operated by a salesclerk or a customer.
The processing apparatus 10 displays an inquiry screen for a customer who requests issue of an electronic receipt.

A hardware configuration of the processing apparatus 10 is similar to that in the first to sixth example embodiments. One example of a functional block diagram of the processing apparatus 10 is illustrated in FIG. 3. A configuration of a customer identification information acquisition unit 11, a request information acquisition unit 12, a display control unit 13, and a paper receipt issuing unit 14 is similar to that in the first to sixth example embodiments.

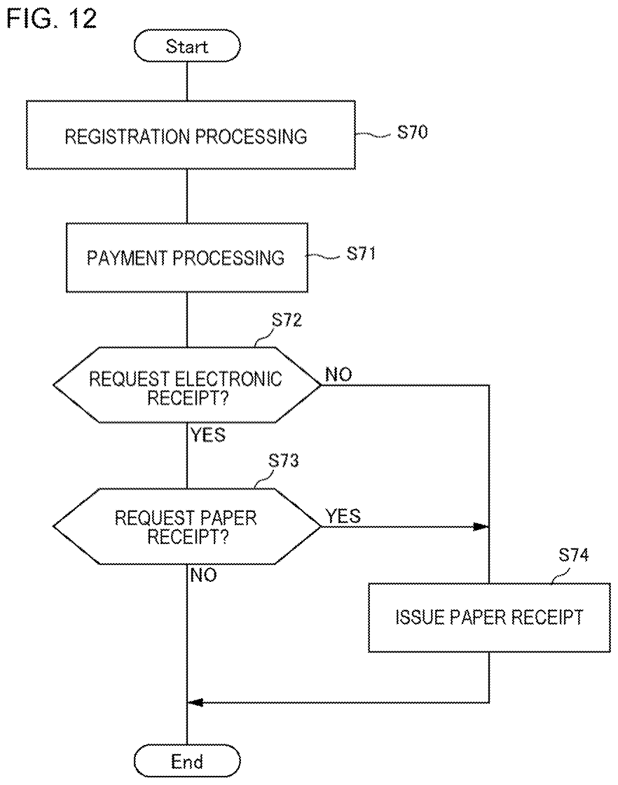

Herein, one example of a flow of processing of the processing apparatus 10 will be described by using a flowchart in FIG. 12.

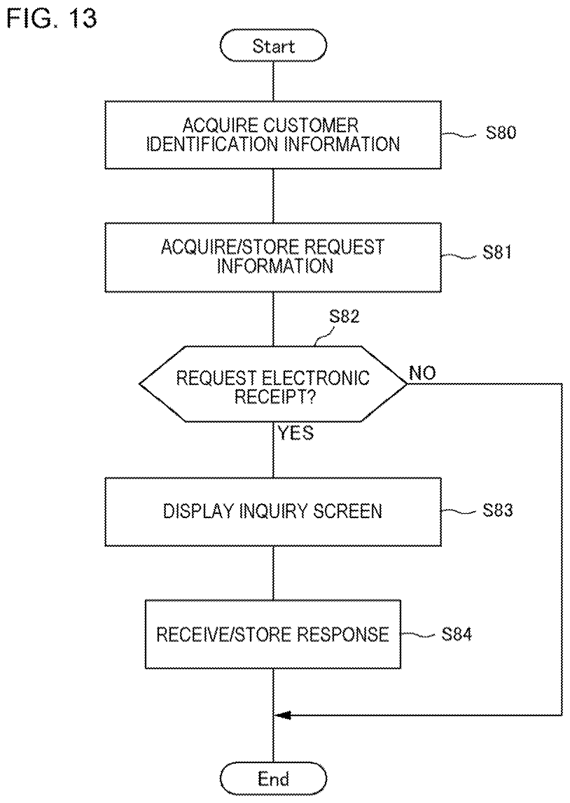

First, the processing apparatus 10 performs registration processing (S70). A content of the processing in S70 is similar to the processing content in S10 described in the second example embodiment. Further, the processing apparatus 10 can perform processing illustrated in a flowchart in FIG. 13 at any timing during the registration processing.

First, the processing apparatus 10 receives an input of customer identification information, and acquires the customer identification information (S80). A salesclerk or a customer inputs the customer identification information via an input apparatus included in the processing apparatus 10 or an input apparatus connected to the processing apparatus 10. A reader/writer, a card reader, a physical button, a touch panel, a microphone, a camera, and the like are exemplified as the input apparatus, which is not limited thereto.

Then, the processing apparatus 10 acquires, from a server, request information stored in association with the acquired customer identification information, and stores the request information (S81). The request information is information indicating whether issue of an electronic receipt is requested.

Next, when a content of the request information requests issue of the electronic receipt (Yes in S82), the processing apparatus 10 displays an inquiry screen on a customer-specific display (S83). The inquiry screen is a screen that inquires about whether to issue a paper receipt, and receives an instruction input indicating whether to issue the paper receipt. For example, the processing apparatus 10 may display an inquiry screen as illustrated in FIG. 11 on the customer-specific display. Then, the processing apparatus 10 receives a response to whether to issue the paper receipt from the inquiry screen, and stores the response (S84).

On the other hand, when the content of the request information does not request issue of the electronic receipt (No in S82), the processing apparatus 10 ends the processing without displaying the inquiry screen on the customer-specific display.

Referring back to FIG. 12, when the processing apparatus 10 receives a user input for starting payment processing, the processing apparatus 10 ends the registration processing in S70, and performs the payment processing (S71). Subsequently, the processing apparatus 10 determines whether the customer requests issue of the electronic receipt (S72). Specifically, the processing apparatus 10 reads the request information acquired by performing the processing in FIG. 13 during S70, and confirms the content of the request information.

When the content of the request information requests issue of the electronic receipt (Yes in S72), the processing apparatus 10 confirms whether the customer requests issue of the paper receipt (S73). Specifically, the processing apparatus 10 reads the response (response in S84) to whether issue of the paper receipt is requested being acquired by performing the processing in FIG. 13 during S70, and confirms a content of the response.

When issue of the paper receipt is requested (Yes in S73), the processing apparatus 10 issues the paper receipt (S74), and ends the processing.

On the other hand, when issue of the paper receipt is not requested (No in S73), the processing apparatus 10 ends the processing without issuing the paper receipt.

Further, when the content of the request information does not request issue of the electronic receipt (No in S72), the processing apparatus 10 issues the paper receipt (S74), and ends the processing.

Note that, in the example described above, the processing apparatus 10 performs the processing in FIG. 13 during the registration processing, but the processing apparatus 10 may perform the processing in FIG. 13 after the registration processing ends.

The processing apparatus 10 according to the present example embodiment described above can achieve an advantageous effect similar to that in the first to sixth example embodiments. Further, the processing apparatus 10 according to the present example embodiment can perform, simultaneously with registration processing, display of a screen that inquires about whether to request issue of an electronic receipt, and confirmation work by a customer. As a result, inconvenience that efficiency of checkout processing is reduced due to the screen display and the confirmation work by a customer can be suppressed.

### Eighth Example Embodiment

In a present example embodiment, a configuration of a processing apparatus 10 is defined as follows, and then a specific example of a flow of processing will be described.
The processing apparatus 10 is a checkout apparatus configured with two apparatuses (a registration apparatus and a payment apparatus) being separated physically and logically.
The registration apparatus is an apparatus assumed to be operated by a salesclerk, and the payment apparatus is an apparatus assumed to be operated by a customer.
The processing apparatus 10 displays an inquiry screen for a customer who requests issue of an electronic receipt.

A hardware configuration of the processing apparatus 10 is similar to that in the first to seventh example embodiments. One example of a functional block diagram of the processing apparatus 10 is illustrated in FIG. 3. A configuration of a customer identification information acquisition unit 11, a request information acquisition unit 12, a display control unit 13, and a paper receipt issuing unit 14 is similar to that in the first to seventh example embodiments.

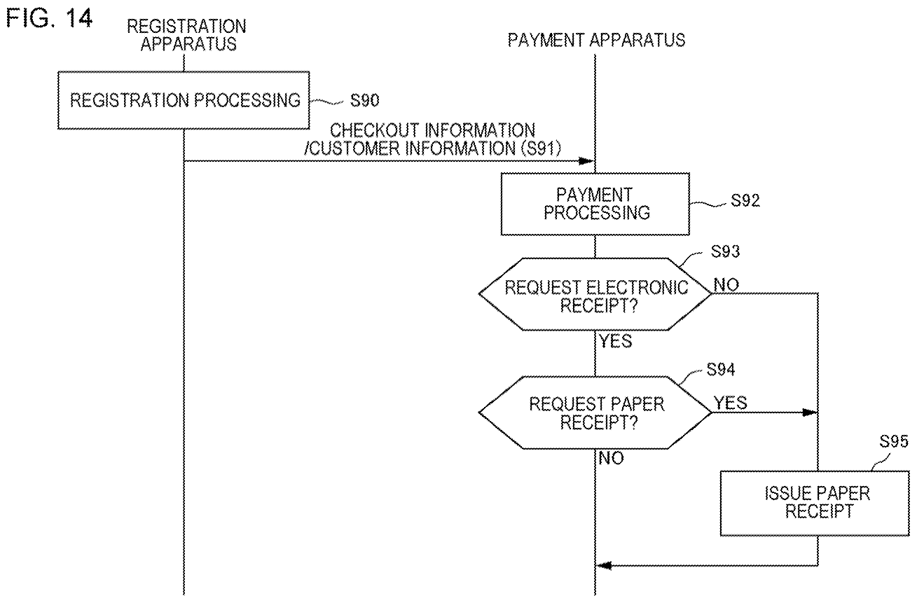

Herein, one example of a flow of processing of the processing apparatus 10 formed of the registration apparatus and the payment apparatus will be described by using a sequence diagram in FIG. 14.

First, the registration apparatus performs registration processing (S90). A content of the processing in S90 is similar to the processing content in S10 described in the second example embodiment. Further, the registration apparatus can perform the processing in FIG. 13 during the registration processing in S90. When the registration apparatus receives a user input for ending the registration processing, the registration apparatus ends the registration processing in S90, and transmits checkout information and customer information to the payment apparatus (S91). The checkout information includes information that identifies a product and a service registered as a checkout target, the number of registered items, a price, presence or absence of a discount, a subtotal, a consumption tax, a checkout amount, and the like. The customer information is, for example, request information acquired by the processing apparatus 10 in the processing in FIG. 13, and a response to whether issue of a paper receipt is requested.

The payment apparatus performs payment processing, based on the checkout information received from the registration apparatus (S92). In the payment processing, for example, the payment apparatus receives insertion of cash, receives an input of credit card information, performs settlement processing by communicating with a server of a credit card company, receives an input of a tendered amount, computes a change, and discharges a computed change.

Next, the payment apparatus determines whether the customer requests issue of an electronic receipt, based on the request information acquired from the registration apparatus (S93).

When a content of the request information requests issue of the electronic receipt (Yes in S93), the payment apparatus determines whether the customer requests issue of a paper receipt, based on the information acquired from the registration apparatus (S94). When the customer requests issue of the paper receipt (Yes in S94), the payment apparatus issues the paper receipt (S95), and ends the processing. On the other hand, when the customer does not request issue of the paper receipt (No in S94), the payment apparatus ends the processing without issuing the paper receipt.

When the content of the request information does not request issue of the electronic receipt (No in S93), the payment apparatus issues the paper receipt (S95), and ends the processing.

Note that, in the example described above, the registration apparatus performs the processing in FIG. 13 during the registration processing, but the registration apparatus may perform the processing in FIG. 13 after the registration processing ends. In addition, after the payment apparatus acquires checkout information from the registration apparatus, the payment apparatus may perform the processing in FIG. 13.

In addition, the registration apparatus may receive an input of customer identification information, but may not perform processing of acquiring request information from a server. In this case, the registration apparatus transmits, as customer information, the input customer identification information to the payment apparatus (S91). Then, the payment apparatus performs the processing in FIG. 13 by using the customer identification information acquired from the registration apparatus.

The processing apparatus 10 according to the present example embodiment described above can achieve an advantageous effect similar to that in the first to seventh example embodiments.

### Ninth Example Embodiment

In a present example embodiment, a configuration of a processing apparatus 10 is defined as follows, and then a specific example of a flow of processing will be described. Note that, the following conditions of the processing apparatus 10 are similar to those in the eighth example embodiment.
The processing apparatus 10 is a checkout apparatus configured with two apparatuses (a registration apparatus and a payment apparatus) being separated physically and logically.
The registration apparatus is an apparatus assumed to be operated by a salesclerk, and the payment apparatus is an apparatus assumed to be operated by a customer.
The processing apparatus 10 displays an inquiry screen for a customer who requests issue of an electronic receipt.

A hardware configuration of the processing apparatus 10 is similar to that in the first to eighth example embodiments. One example of a functional block diagram of the processing apparatus 10 is illustrated in FIG. 3. A configuration of a customer identification information acquisition unit 11, a request information acquisition unit 12, a display control unit 13, and a paper receipt issuing unit 14 is similar to that in the first to eighth example embodiments.

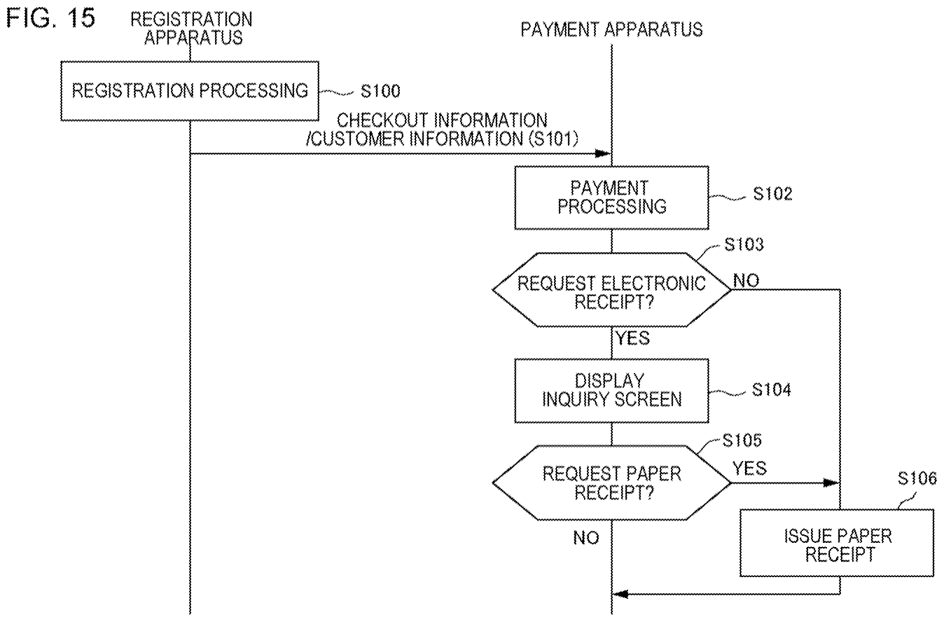

Herein, one example of a flow of processing of the processing apparatus 10 formed of the registration apparatus and the payment apparatus will be described by using a sequence diagram in FIG. 15.

First, the registration apparatus performs registration processing (S100). A content of the processing in S100 is similar to the processing content in S10 described in the second example embodiment. Further, the registration apparatus can perform the processing in FIG. 5 during the registration processing in S100. When the registration apparatus receives a user input for ending the registration processing, the registration apparatus ends the registration processing in S100, and transmits checkout information and customer information to the payment apparatus (S101). The checkout information includes information that identifies a product and a service registered as a checkout target, the number of registered items, a price, presence or absence of a discount, a subtotal, a consumption tax, a checkout amount, and the like. The customer information is, for example, request information acquired by the processing apparatus 10 in the processing in FIG. 5.

The payment apparatus performs payment processing, based on the checkout information received from the registration apparatus (S102). In the payment processing, for example, the payment apparatus receives insertion of cash, receives an input of credit card information, performs settlement processing by communicating with a server of a credit card company, receives an input of a tendered amount, computes a change, and discharges a computed change.

Next, the payment apparatus determines whether the customer requests issue of an electronic receipt, based on the request information acquired from the registration apparatus (S103).

When a content of the request information requests issue of the electronic receipt (Yes in S103), the payment apparatus displays an inquiry screen on a customer-specific display (S104). The inquiry screen is a screen that inquires about whether to issue a paper receipt, and receives an instruction input indicating whether to issue the paper receipt. For example, the payment apparatus may display an inquiry screen as illustrated in FIG. 11 on the customer-specific display.

When an instruction input for issuing a paper receipt is received on the inquiry screen (Yes in S105), the payment apparatus issues the paper receipt (S106), and ends the processing.

On the other hand, when the instruction input for issuing the paper receipt is not received on the inquiry screen (No in S105), the payment apparatus ends the processing without issuing the paper receipt.

Further, when the content of the request information does not request issue of the electronic receipt (No in S103), the payment apparatus issues the paper receipt (S106), and ends the processing.

Note that, in the example described above, the registration apparatus performs the processing in FIG. 5 during the registration processing, but the registration apparatus may perform the processing in FIG. 5 after the registration processing ends. In addition, after the payment apparatus acquires checkout information from the registration apparatus, the payment apparatus may perform the processing in FIG. 5.

In addition, the registration apparatus may receive an input of customer identification information, but may not perform processing of acquiring request information from a server. In this case, the registration apparatus transmits, as customer information, the input customer identification information to the payment apparatus (S101). Then, the payment apparatus performs the processing in FIG. 5 by using the customer identification information acquired from the registration apparatus.

The processing apparatus 10 according to the present example embodiment described above can achieve an advantageous effect similar to that in the first to eighth example embodiments.

### Tenth Example Embodiment

A processing apparatus 10 according to a present example embodiment is different from that in the first to ninth example embodiments in a point that, when a customer requests issue of an electronic receipt and a product and a service that satisfy a predetermined condition are registered as a checkout target, at least either one of an inquiry screen and a checkout details screen is displayed on a customer-specific display.

A hardware configuration of the processing apparatus 10 is similar to that in the first to ninth example embodiments. One example of a functional block diagram of the processing apparatus 10 is illustrated in FIG. 2 or 3. A configuration of a customer identification information acquisition unit 11, a request information acquisition unit 12, and a paper receipt issuing unit 14 is similar to that in the first to ninth example embodiments.

When a content of request information acquired by the request information acquisition unit 12 requests issue of an electronic receipt, and a notification requiring product and a notification requiring service are included in a product and a service registered as a checkout target, a display control unit 13 displays, on the customer-specific display, at least either one of an inquiry screen and a checkout details screen.

For example, as the notification requiring product and the notification requiring service, a product with discount, a service with discount, a high-priced product (product equal to or more than ∘∘∘ yen), a high-priced service (service equal to or more than ∘∘∘ yen), a product in which the number of purchased items is two or more, a service in which the number of purchased items is two or more, and the like are exemplified.

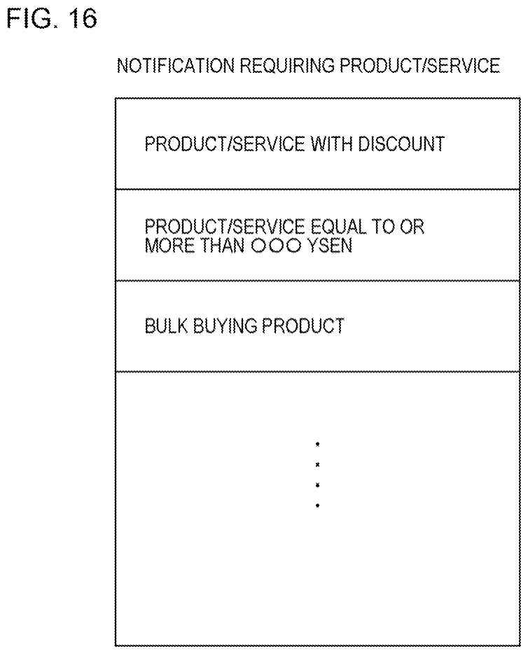

For example, a notification requiring product and a notification requiring service may be registered in advance as illustrated in FIG. 16, and the display control unit 13 may recognize the notification requiring product and the notification requiring service, based on the registration information.

In addition, the registration information as illustrated in FIG. 16 may be registered for each customer. In other words, a customer himself/herself may be able to register the notification requiring product and the notification requiring service. In this case, the registration information may be stored in a server. Then, the display control unit 13 may acquire, from the server, the registration information stored in association with customer identification information acquired by the customer identification information acquisition unit 11.

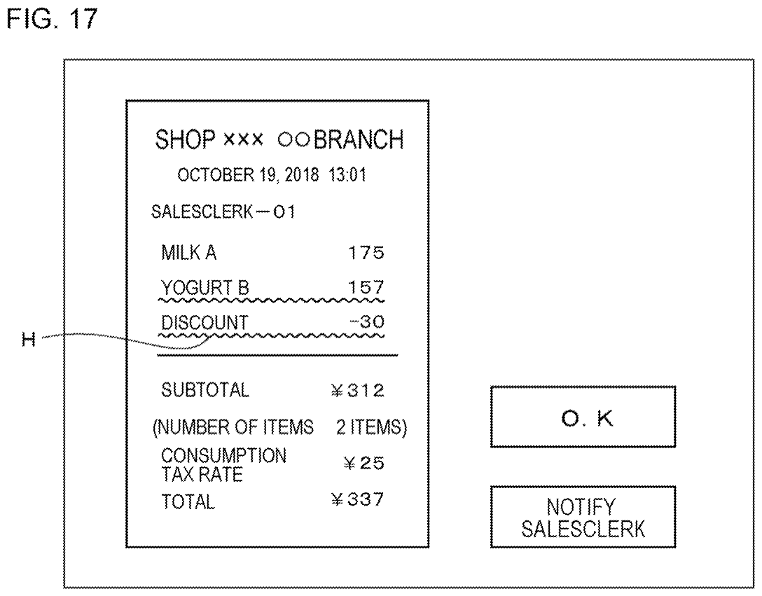

Further, when the display control unit 13 displays, on a customer-specific display, a checkout details screen displaying a list of a product and a service to be checked out, the display control unit 13 may emphasize and display a notification requiring product and a notification requiring service as illustrated in FIG. 17. The emphasized display may be achieved by drawing an underline H as illustrated, and may be achieved by another means.

Another configuration of the display control unit 13 is similar to that in the first to ninth example embodiments.

The processing apparatus 10 according to the present example embodiment described above can achieve an advantageous effect similar to that in the first to ninth example embodiments.

Further, the processing apparatus 10 according to the present example embodiment provides an inquiry screen and a checkout details screen to only a customer who registers a predetermined product or a predetermined service as a checkout target instead of providing the inquiry screen and the checkout details screen to all customers who request issue of an electronic receipt. Thus, a reduction in efficiency of checkout processing can be suppressed.

### Eleventh Example Embodiment

A processing apparatus 10 according to a present example embodiment is different from that in the first to tenth example embodiments in a point that, when a customer requests issue of an electronic receipt and a checkout amount is equal to or more than a reference value, at least either one of an inquiry screen and a checkout details screen is displayed on a customer-specific display.

A hardware configuration of the processing apparatus 10 is similar to that in the first to tenth example embodiments. One example of a functional block diagram of the processing apparatus 10 is illustrated in FIG. 2 or 3. A configuration of a customer identification information acquisition unit 11, a request information acquisition unit 12, and a paper receipt issuing unit 14 is similar to that in the first to tenth example embodiments.

When a content of request information acquired by the request information acquisition unit 12 requests issue of an electronic receipt, and a checkout amount is equal to or more than a notification requiring amount, a display control unit 13 displays, on the customer-specific display, at least either one of an inquiry screen and a checkout details screen.

The notification requiring amount may be the same for all customers, and may be different for each customer. When the notification requiring amount is different for each customer, the notification requiring amount for each customer may be registered in advance in a server. Note that, each customer himself/herself may be able to set a notification requiring amount. In this case, the display control unit 13 may acquire, from the server, the notification requiring amount stored in association with customer identification information acquired by the customer identification information acquisition unit 11.

The processing apparatus 10 according to the present example embodiment described above can achieve an advantageous effect similar to that in the first to tenth example embodiments.

Further, the processing apparatus 10 according to the present example embodiment provides an inquiry screen and a checkout details screen to only a customer having a checkout amount equal to or more than a predetermined value instead of providing the inquiry screen and the checkout details screen to all customers who request issue of an electronic receipt. Thus, a reduction in efficiency of checkout processing can be suppressed.

Hereinafter, examples of reference manners are presented as supplementary notes.

1. A processing apparatus, including:

a customer identification information acquisition unit that acquires customer identification information;

a request information acquisition unit that acquires, from a server that stores customer registration information in which request information indicating whether issue of an electronic receipt is requested is registered in association with the customer identification information, the request information stored in association with the customer identification information acquired by the customer identification information acquisition unit; and

a display control unit that displays, on a display, at least either one of an inquiry screen that inquires about whether to issue a paper receipt and a checkout details screen indicating at least a part of information included in an electronic receipt, when a content of the acquired request information requests issue of the electronic receipt.

2. The processing apparatus according to supplementary note 1, further including

a paper receipt issuing unit that issues a paper receipt when an instruction input for issuing a paper receipt is received on the inquiry screen.

3. The processing apparatus according to supplementary note 1 or 2, wherein

the display control unit displays, on the display, at least either one of the inquiry screen and the checkout details screen when a notification requiring product and a notification requiring service are included in a product and a service to be checked out.

4. The processing apparatus according to supplementary note 3, wherein

the display control unit displays a list of a product and a service to be checked out on the checkout details screen, and emphasizes and displays the notification requiring product and the notification requiring service.

5. The processing apparatus according to supplementary note 3 or 4, wherein

the display control unit acquires, from a server that stores registration information in which the notification requiring product and the notification requiring service are registered in association with the customer identification information, the registration information associated with the customer identification information acquired by the customer identification information acquisition unit.

6. The processing apparatus according to any of supplementary notes 1 to 5, wherein

the display control unit displays, on the display, at least either one of the inquiry screen and the checkout details screen when a checkout amount is equal to or more than a notification requiring amount.

7. The processing apparatus according to supplementary note 6, wherein

the display control unit acquires, from a server that registers the notification requiring amount in association with the customer identification information, the notification requiring amount associated with the customer identification information acquired by the customer identification information acquisition unit.

8. The processing apparatus according to any of supplementary notes 1 to 7, in which

the display control unit displays the checkout details screen, the processing apparatus further including:

a warning unit that performs warning processing in response to a user input.

9. The processing apparatus according to any of supplementary notes 1 to 8, wherein

the processing apparatus is a registration apparatus that receives an input of information that identifies a product and a service to be checked out, and registers an input product and an input service as a checkout target.

10. The processing apparatus according to any of supplementary notes 1 to 9, wherein

the processing apparatus is a payment apparatus that acquires a checkout amount from a registration apparatus, and performs payment processing.

11. A processing method executed by a computer, including:

a customer identification information acquisition step of acquiring customer identification information;

a request information acquisition step of acquiring, from a server that stores customer registration information in which request information indicating whether issue of an electronic receipt is requested is registered in association with the customer identification information, the request information stored in association with the customer identification information acquired in the customer identification information acquisition step; and

a display control step of displaying, on a display, at least either one of an inquiry screen that inquires about whether to issue a paper receipt and a checkout details screen indicating at least a part of information included in an electronic receipt, when a content of the acquired request information requests issue of the electronic receipt.

12. A program for causing a computer to function as:

a customer identification information acquisition unit that acquires customer identification information;

a request information acquisition unit that acquires, from a server that stores customer registration information in which request information indicating whether issue of an electronic receipt is requested is registered in association with the customer identification information, the request information stored in association with the customer identification information acquired by the customer identification information acquisition unit; and

a display control unit that displays, on a display, at least either one of an inquiry screen that inquires about whether to issue a paper receipt and a checkout details screen indicating at least a part of information included in an electronic receipt, when a content of the acquired request information requests issue of the electronic receipt.

This application is based upon and claims the benefit of priority from Japanese patent application No. 2018-247637, filed on Dec. 28, 2018, the disclosure of which is incorporated herein in its entirety by reference.

What is claimed is:

1. A processing apparatus, comprising:
at least one memory configured to store one or more instructions; and
at least one processor configured to execute the one or more instructions to:
acquire customer identification information;
acquire, from a server that stores customer registration information in which request information indicating whether issue of an electronic receipt is requested is registered in association with the customer identification information, the request information stored in association with the customer identification information; and
display, on a display, at least either one of an inquiry screen that inquires about whether to issue a paper receipt and a checkout details screen indicating at least a part of information included in an electronic receipt, when a content of the acquired request information requests issue of the electronic receipt.

2. The processing apparatus according to claim 1,
wherein the processor is further configured to execute the one or more instructions to issue a paper receipt when an instruction input for issuing a paper receipt is received on the inquiry screen.

3. The processing apparatus according to claim 1,
wherein the processor is further configured to execute the one or more instructions to display, on the display, at least either one of the inquiry screen and the checkout details screen when a notification requiring product and a notification requiring service are included in a product and a service to be checked out.

4. The processing apparatus according to claim 3,
wherein the processor is further configured to execute the one or more instructions to display a list of a product and a service to be checked out on the checkout details screen, and emphasize and display the notification requiring product and the notification requiring service.

5. The processing apparatus according to claim 3,
wherein the processor is further configured to execute the one or more instructions to acquire, from a server that stores registration information in which the notification requiring product and the notification requiring service are registered in association with the customer identification information, the registration information associated with the customer identification information.

6. The processing apparatus according to claim 1,
wherein the processor is further configured to execute the one or more instructions to display, on the display, at least either one of the inquiry screen and the checkout details screen when a checkout amount is equal to or more than a notification requiring amount.

7. The processing apparatus according to claim 6,
wherein the processor is further configured to execute the one or more instructions to acquire, from a server that registers the notification requiring amount in association with the customer identification information, the notification requiring amount associated with the customer identification information.

8. The processing apparatus according to claim 1,
wherein the processor is further configured to execute the one or more instructions to:
display the checkout details screen, and
perform warning processing in response to a user input.

9. The processing apparatus according to claim 1 wherein
the processing apparatus is a registration apparatus that receives an input of information that identifies a product and a service to be checked out, and registers an input product and an input service as a checkout target.

10. The processing apparatus according to claim 1 wherein
the processing apparatus is a payment apparatus that acquires a checkout amount from a registration apparatus, and performs payment processing.

11. A processing method executed by a computer, comprising:
acquiring customer identification information;
acquiring, from a server that stores customer registration information in which request information indicating whether issue of an electronic receipt is requested is registered in association with the customer identification information, the request information stored in association with the customer identification information; and
displaying, on a display, at least either one of an inquiry screen that inquires about whether to issue a paper receipt and a checkout details screen indicating at least a part of information included in an electronic receipt, when a content of the acquired request information requests issue of the electronic receipt.

12. A non-transitory storage medium storing a program for causing a computer to:
acquire customer identification information;
acquire, from a server that stores customer registration information in which request information indicating whether issue of an electronic receipt is requested is registered in association with the customer identification information, the request information stored in association with the customer identification information; and
display, on a display, at least either one of an inquiry screen that inquires about whether to issue a paper receipt and a checkout details screen indicating at least a part of information included in an electronic receipt, when a content of the acquired request information requests issue of the electronic receipt.
